(19) United States
(12) Patent Application Publication
(10) Pub. No.: US 2007/0165624 A1
(43) Pub. Date: Jul. 19, 2007

(54) Operation management system

(76) Inventors: Hiroshi Saito, Kawasaki (JP); Yukio Ogawa, Tokyo (JP); Yuji Kimura, Kawasaki (JP); Toshikazu Yasue, Chigasaki (JP); Satoshi Nakagawa, Saitama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/451,368

(22) Filed: Jun. 13, 2006

(30) Foreign Application Priority Data
Jan. 18, 2006 (JP) 2006-009390

(51) Int. Cl. H04L 12/56; H04L 12/28

(52) U.S. Cl. 370/389

(57) ABSTRACT

In a network system, which has a first computer belonging to a first network, a second computer belonging to a second network, and a first router and a second router belonging to a third network, wherein the first computer and the second computer are connected through a logical path built between the first router and the second router, wherein the first, second and third network are connected to one another, wherein the first and second network and the third network are independently operated; the first router stores as its first address an address used by the first network but not used by the first computer, or an address used by the second network but not used by the second computer and, based on the first address, sends a first packet and receives a second packet corresponding to the first packet.

### INCORPORATION BY REFERENCE

The present application claims priority from Japanese application JP 2006-009390 filed on Jan. 18, 2006, the content of which is hereby incorporated by reference into this application.

### BACKGROUND OF THE INVENTION

The present invention relates to a management of communication channels such as a VPN (Virtual Private Network).

There is a VPN technology that builds one or more logical virtual dedicated IP network on a physical shared IP network. With this technology, when two or more users use the network, routers making up the logical, virtual communication channels (hereinafter called VPN paths) make a decision on whether a traffic may or may not pass the VPN path for each user and distribute the traffic among a plurality of VPN paths.

In an ordinary network operation management, a technique is available in which, when VPN paths are interrupted and restored, computers using the VPN paths send out test packets by using a program, such as Ping and Traceroute, to check if the VPN paths are normally restored and thereby verify the normalcy of the VPN paths (for reference: Masayoshi Shibafuji, “Building Safe Network with IP Sec—Recommendations for Encrypted Communications [online], HP Jun. 25, 2002 published by Mainichi Communication [Date of search: Jan. 11, 2006] Internet <URL: http://pcweb.mycom.co.jp/special/2002/ipsec/018.html>). This technique checks a source IP address of an ICMP (Internet Control Message Protocol) packet sent from a particular computer and distributes the packet among the VPN paths used by the computer and sends it to a destination computer.

### SUMMARY OF THE INVENTION

In checking a communication establishment of a VPN path in an IP network, a network provider that provides network services normally sends a test packet from a computer of a user network and checks if the packet passes through the VPN path, to determine the normalcy of the network.

There are, however, times when the test packet cannot be sent from the user network. That is, if the user network and the network provider's network are independent of each other (Their management organizers are different from each other.), the network provider cannot use the user computer. Under this circumstance, to verify a communication establishment of the VPN path requires sending a test packet from a router under the control of the network provider. The VPN path, however, passes only those packets containing a source address of a format used in the user network. Thus, the packets containing a source address of a format used in the network provider's network do not pass the VPN path.

It is also possible for the network provider to ask the user to perform the communication establishment verification on the VPN path. However, as the number of users, computers and VPN paths is growing rapidly, such an operation management is not practical.

It is therefore an object of this invention to provide an operation management system that can verify a communication establishment of a VPN path by operating the network provider's devices without using the user's facilities.

One preferred configuration of this invention to achieve the above objective is as follows.

In a network system, which has a first computer belonging to a first network, a second computer belonging to a second network, and a first router and a second router belonging to a third network, wherein the first computer and the second computer are connected through a logical path built between the first router and the second router, wherein the first, second and third network are connected to one another, wherein the first and second network and the third network are independently operated; the first router stores as its first address an address used by the first network but not used by the first computer, or an address used by the second network but not used by the second computer and, based on the first address, sends a first packet and receives a second packet corresponding to the first packet.

Other objects, features and advantages of the invention will become apparent from the following description of the embodiments of the invention taken in conjunction with the accompanying drawings.

### BRIEF DESCRIPTION OF THE DRAWINGS

FIG. 1 is a configuration of an operation management system.

FIG. 2 is a hardware configuration of a router.

FIG. 3 is a hardware configuration of a computer.

FIG. 4 is a software configuration of a network management device 300e.

FIG. 5 shows information in DB 405.

FIG. 6 is a flow diagram showing steps to search paths.

FIG. 7 is an example screen displaying information retrieved from database.

FIG. 8 is an example screen showing a result of search made by the flow of FIG. 6.

FIG. 9 is a flow diagram showing steps to verify the path communication.

FIGS. 10A and 10B are example screens displaying results of path communication verifications.

### DESCRIPTION OF THE EMBODIMENTS

Now, by referring to the accompanying drawings, embodiments of this invention will be described.

### Embodiment 1

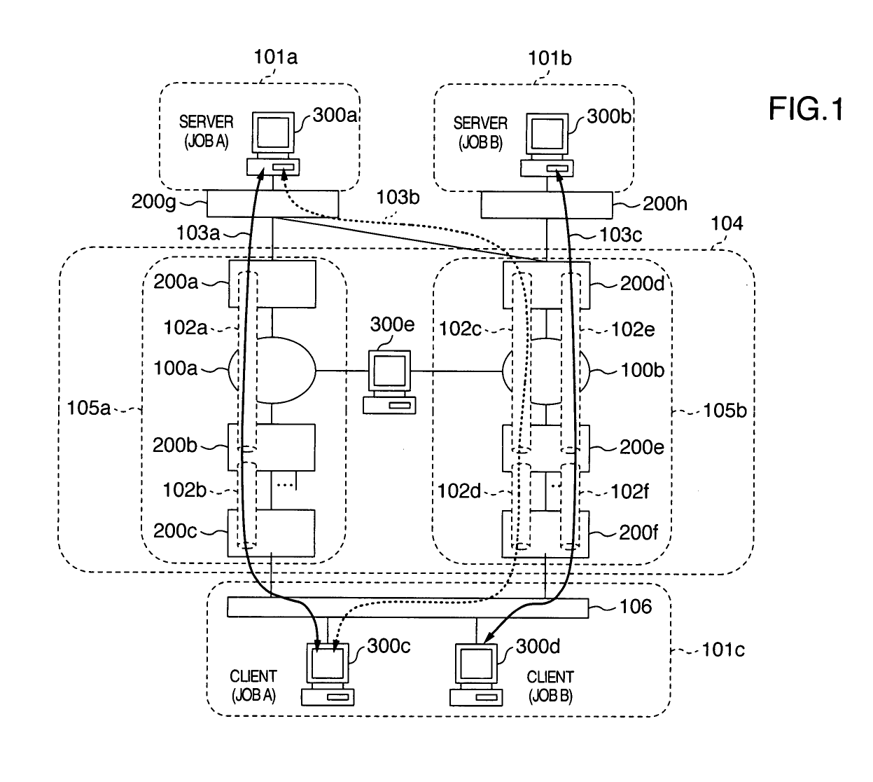

FIG. 1 shows an operation management system.

The operation management system comprises endpoints 101 (101a-10c) where computers are installed, and a network 104 providing VPN. These are connected through routers 200 (200g, 200h) and a switch 106.

The VPN network 104 comprises an operational system 105a and a standby system 105b. Normally, the operational system 105a is used. In the event of a failure of the operational system 105a, it is switched over to the standby system 105b. Among possible communication failures are router failures, communication line failures between routers, and VPN path failures.

The operational system 105a includes routers 200 (200a-200c) and a shared network 100a provided by a carrier. The routers 200 along with other routers 200 build VPN paths 102 (102a, 102b). The standby system 105b also has the similar configuration.

The routers 200a-200f are owned by a network provider and the routers 200g and 200h by a user. Though not shown, at least one router owned by the carrier exists in the shared network 100a (10b).

A network management device 300e connects the shared network 100a in the operational system 105a to the shared network 100b in the standby system 105b to execute the network operation management, such as operation management, failure management and configuration management.

A plurality of computers 300 are connected with one another via VPN paths 102. The endpoints 101a, 101b, 101c may or may not be the same endpoints or virtual endpoints.

A server 300a installed in the endpoint 101a that executes a job A communicates, through VPN paths 102a, 102b, with a client 300c installed in the endpoint 101c that executes a job A. A server 300b installed in the endpoint 101b that executes a job B communicates, through VPN paths 102e, 102f, with a client 300d installed in the endpoint 101c that executes a job B. In the event of a communication failure, the communication channel is switched over to VPNs 102c, 102d. Denoted 103 (103a-103c) are paths through which data flows.

The endpoints 101a and 101b to which the servers belong are a first network to which the user belongs; the endpoint 101c the clients belong to is a second network to which the user belongs; and the VPN network 104 is a third network of the network provider. The first, second and third network are independent of each other (Their management organizers are different from each other.).

In this embodiment, the router 200a (200d) generates a test packet and sends it to the router 200b (200e) or router 200c (200f) or one of the computers 300. The router or computer that has received the test packet generates an acknowledge packet and returns it to the source router. Any router may generate and send the test packet as long as they are within the VPN network 104.

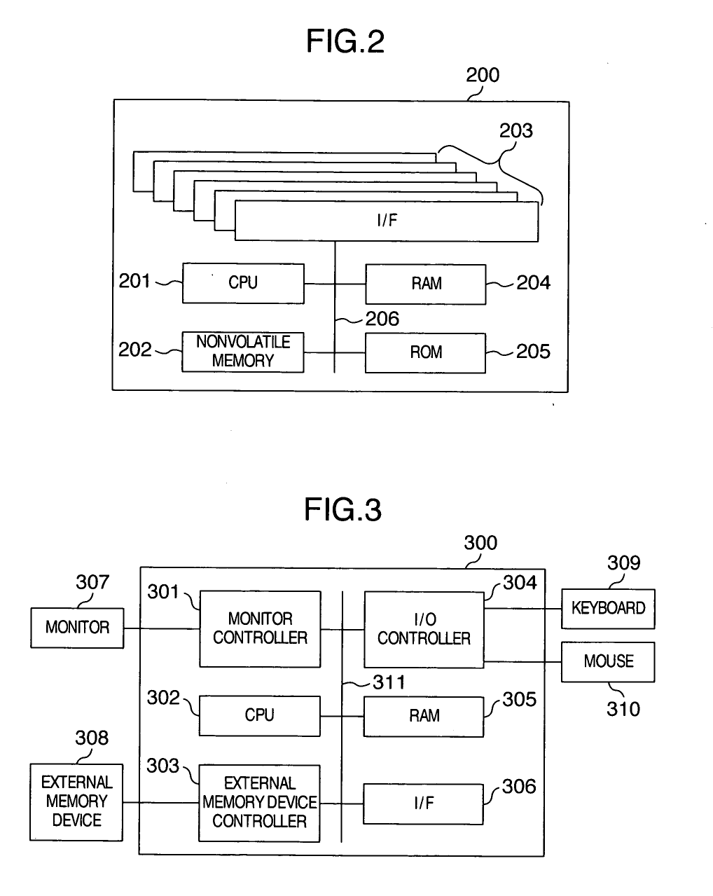

FIG. 2 is a hardware configuration diagram of the router 200.

The router 200 includes a CPU 201, a nonvolatile memory 202, a plurality of network interfaces (abbreviated IF) 203, a RAM 204 and a ROM 205. These are connected through a communication line 206.

FIG. 3 shows a hardware configuration of the computer 300.

The computer 300 comprises a monitor controller 301, a CPU 302, an external storage device controller 303, an input/output controller 304, a RAM 305 and an I/F 306. These are interconnected through a communication line 311. A monitor 307 is connected to the monitor controller 301, an external storage device 308 to the external storage device controller 303, and a keyboard 309 and a mouse 310 to the input/output controller 304.

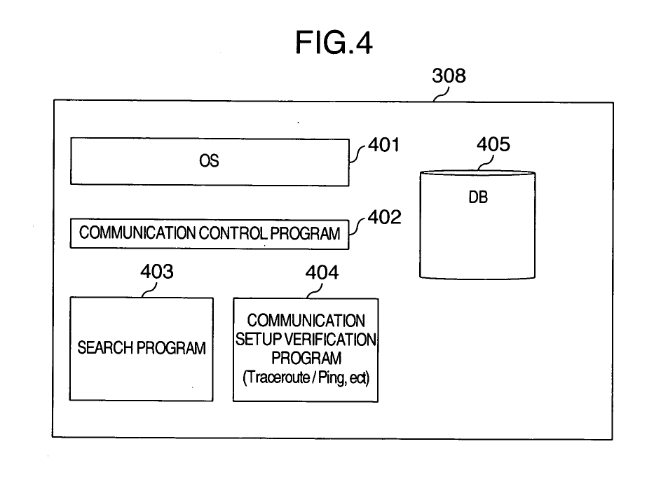

FIG. 4 is a software configuration diagram showing programs installed in the external storage device 308 of the network management device 300e. The external storage device stores an OS 401 for controlling and managing hardware and software, a communication control program 402 for controlling the I/F 306 and for managing information required to communicate with other devices, a search program 403 to search physical paths and VPN paths built on the VPN network 104, and a communication setup verification program 404 to check for an establishment of communication path by using information stored in a database (abbreviated DB) 405. The CPU 302 loads these programs into the RAM 305 for execution.

Examples of the communication setup verification program 404 include Ping and Traceroute.

The Ping is a program to check for the establishment of communication between computers connected to the IP network. The check for the communication establishment involves one of computers in a communication segment of interest specifying an IP address of a destination computer, sending data by using ICMP or UDP and checking if there is any response from the destination computer. If the response is returned, the transmission time between the computers can also be obtained.

The Traceroute is a program to check for a path running through the routers installed between the computers. With this program it is possible to determine what kind of routers are installed in the path. For example, if the establishment of communication cannot be verified by Ping, the Traceroute can check, based on the path information of the router, if the setting of the computer itself and the router is correct or not. Further, since the statistical values, such as communication response time to each router, can be obtained, a bottleneck on paths can also be searched.

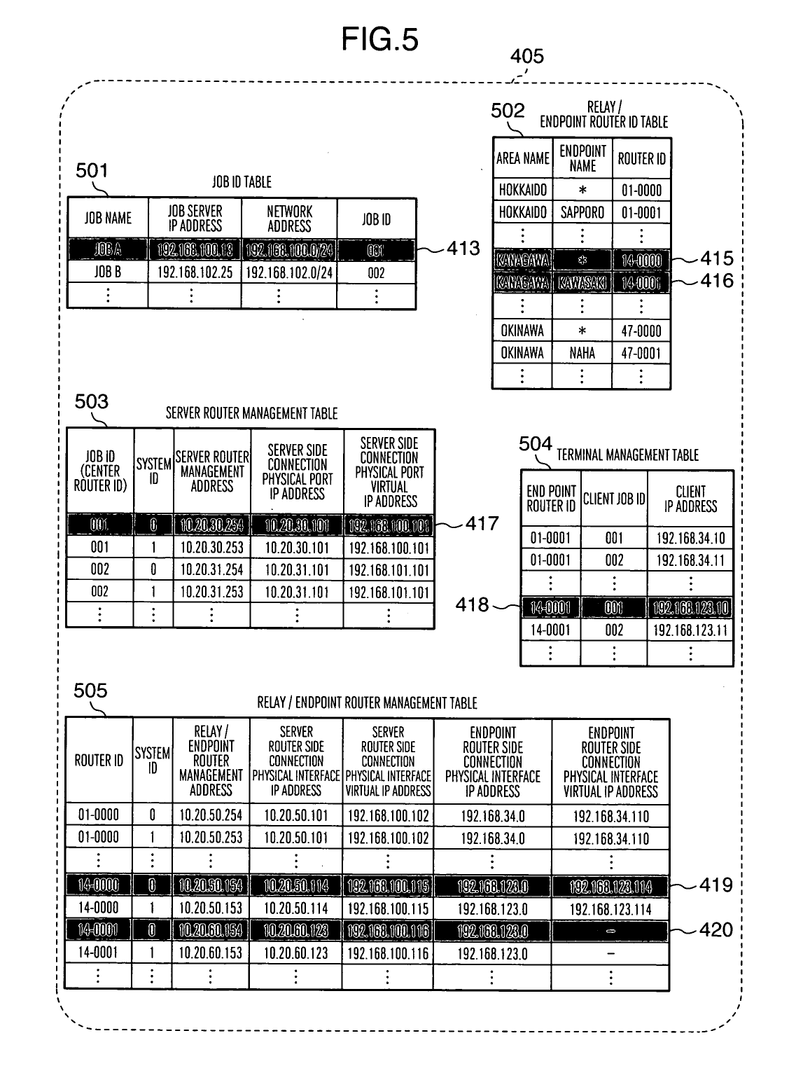

FIG. 5 shows information stored in the DB 405.

A job ID table 501 stores names of services executed by servers, IP addresses of the servers, and job IDs to uniquely identify services, with these data related to each other. In a network of a financial institution, the services may include, for example, information services, accounting services and administrative services.

A relay/endpoint router ID table 502 stores names of areas in which routers are installed, names of endpoints and router IDs to uniquely identify routers, with these data related to each other. Two rows of data form one set. For example, an entry 415 represents a relay router, and an entry 416 represents endpoint routers connected to the relay router. In this embodiment, routers accommodating computers 300c, 300d are called endpoint routers (200c, 200f), and routers connecting a plurality of endpoint routers are called relay routers (200b, 200e). For example, the endpoint routers are those installed at nationwide local offices (such as Yokohama Branch Office, Kanagawa Branch Office, etc.) and the relay routers are those that connect endpoints routers located within a particular prefecture. The relay routers have no endpoint, so they are indicated by “*” marking.

A server router management table 503 stores the job IDs of the job ID table 501 to identify the services that the routers adjoining the servers (hereinafter referred to as server routers) 200a, 200d use. In connection with the job IDs, the server router management table 503 also includes system IDs (0 when the system is the operational system 105a; 1 when it is the standby system 105b), management IP address of the server routers, IP addresses of I/F physical ports on the server side, one of IP addresses not used by the first network (hereinafter referred to as a virtual IP address).

A terminal management table 504 stores endpoint router IDs to uniquely identify endpoint routers, job IDs of adjoining clients, and IP addresses of the same clients.

A relay/endpoint router management table 505 stores router IDs, system IDs, management addresses, IP addresses of I/Fs through which server router are connected to networks on their path, virtual IP addresses of first networks to which servers assigned to the I/Fs belong, IP addresses of the I/Fs through which endpoint routers are connected to networks on their path, and virtual IP addresses of second networks to which endpoint clients assigned to the I/Fs belong. If there are endpoint routers, it is not necessary to store the virtual IP addresses of the networks to which the clients connected to the endpoint routers belong. These tables are stored in the DB 405 when a network is built.

As the virtual address, an address of third layer (layer 3) in the OSI (Open Systems Interconnection) layer model is used.

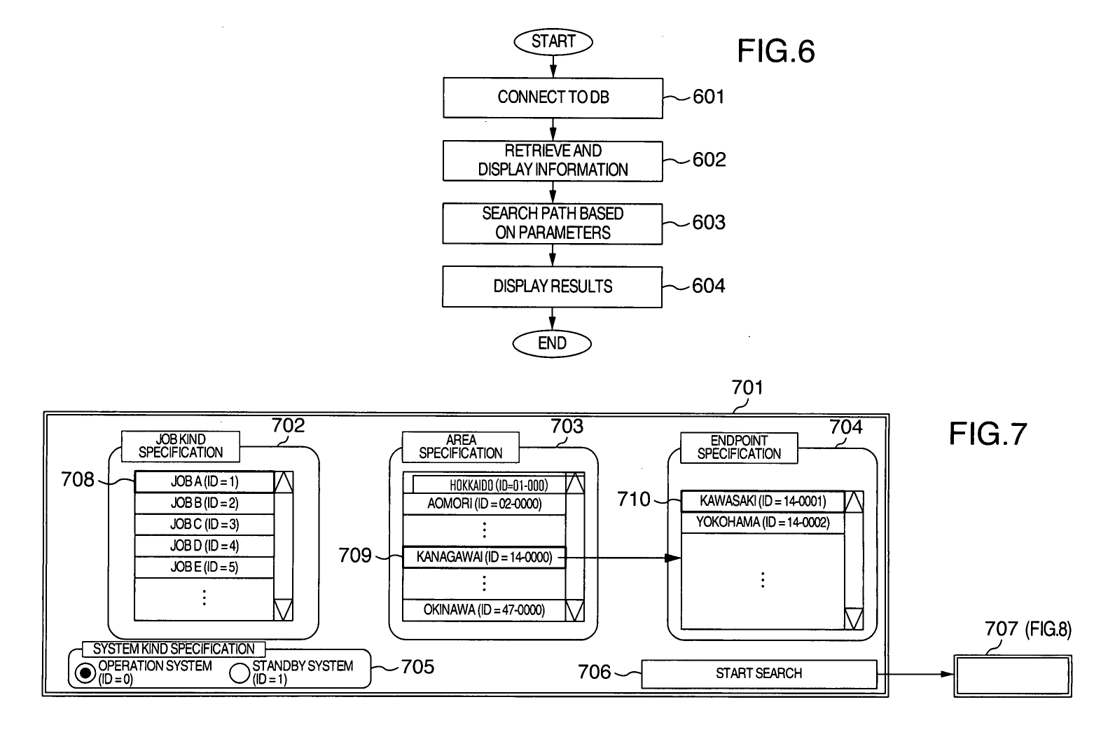

FIG. 6 is a flow diagram showing steps to search a path. The CPU 302 starts processing, triggered by the start of the network management device 300e (or by the manual start by a network administrator).

The CPU 302 first connects to the DB 405 (step 601).

Next, it retrieves information from the connected DB 405 (step 602). The information retrieved here is displayed on the monitor 307 of the network management device 300e.

FIG. 7 is an example screen displaying information retrieved from DB.

A job kind specification field 702 on the screen 701 shows job kinds stored in the job ID table 501; an area specification field 703 displays names of areas stored in the relay/endpoint router ID table 502; and an endpoint specification field 704 displays names of endpoints stored in the relay/endpoint router ID table 502.

Next, based on the set parameters, a path search is performed (step 603). The parameters are set by a network administrator operating the screen 701. More specifically, a desired job is selected from those displayed in the job kind specification field 702; a desired area is selected from the area names displayed in the area specification field 703; a desired endpoint is selected from the endpoint names displayed in the endpoint specification field 704; and either the operational system or standby system is chosen in the system kind specification field 705. Then, a search start button is pressed to proceed to the next step. Here, a job A 708 is selected in the job kind specification field 702; Kanagawa 709 is selected in the area specification field 703; Kawasaki 710 is selected in the endpoint specification field 704, and the operational system is chosen in the system kind specification field 705.

In the path search, first, with the job A 708 as a key, the associated entry is searched from the job ID table 501 (entry 413); with the entry 413 as a key, the corresponding entry is searched from the server router management table 503 (entry 417); with Kanagawa 709 and Kawasaki 710 as search keys, the relay/endpoint router ID table 502 is searched (entry 415, 416); with the entry 416 as a key, the terminal management table 504 is searched (entry 418); with the entries 415, 416 as keys, the relay/endpoint router management table 505 is searched (to find entries 419, 420, respectively).

Then, the result of search is displayed on the screen 707 (step 604).

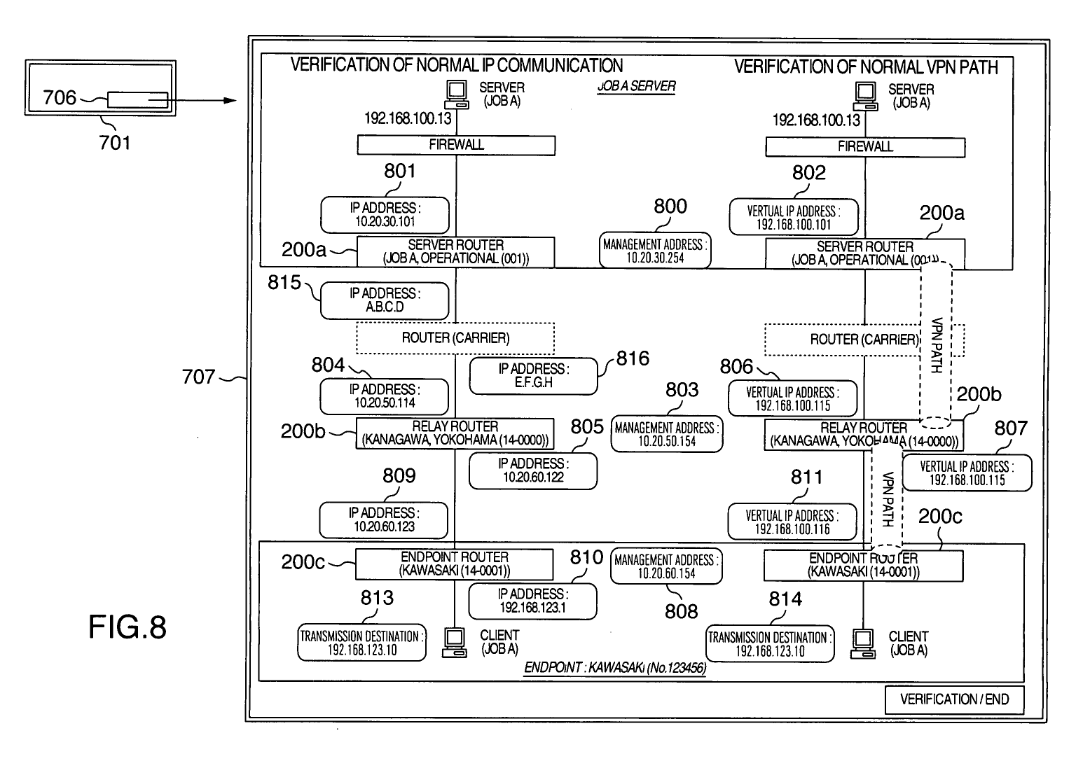

FIG. 8 is an example screen showing the result of search performed by the flow of FIG. 6.

The screen 707 comprises an IP address of a job server that satisfies information specified in this example, a management IP address 800 of a server router, an IP address 801 and a virtual IP address 802 of server side I/F of server router, a management IP address 803 of relay router and an IP address 804 of server router side I/F, a virtual IP address 806 and an IP address 805 and a virtual IP address 807 of endpoint router side I/F, a management IP address 808 of endpoint router and an IP address 809 and a virtual IP address 811 of relay router side I/F, and an IP address 810 and a virtual IP address (if stored) of client side I/F.

As described above, the network administrator can connect the network management device 300e to the network that needs to be used to control routers in a route where the VPN path the server uses is built, by specifying the kind of job and the endpoints and areas where the routers are located.

Next, the network administrator proceeds to a work that verifies the establishment of IP communication path and VPN path by using the communication setup verification program 404 based on the information displayed on the screen 707.

This example considers a case of verifying the establishment of the IP communication path and VPN path between the server and the client that perform the job A, as shown in the screen 707. Here it is assumed that the VPN path 102b between the line colleting router 200b and the endpoint router 200c is cut off.

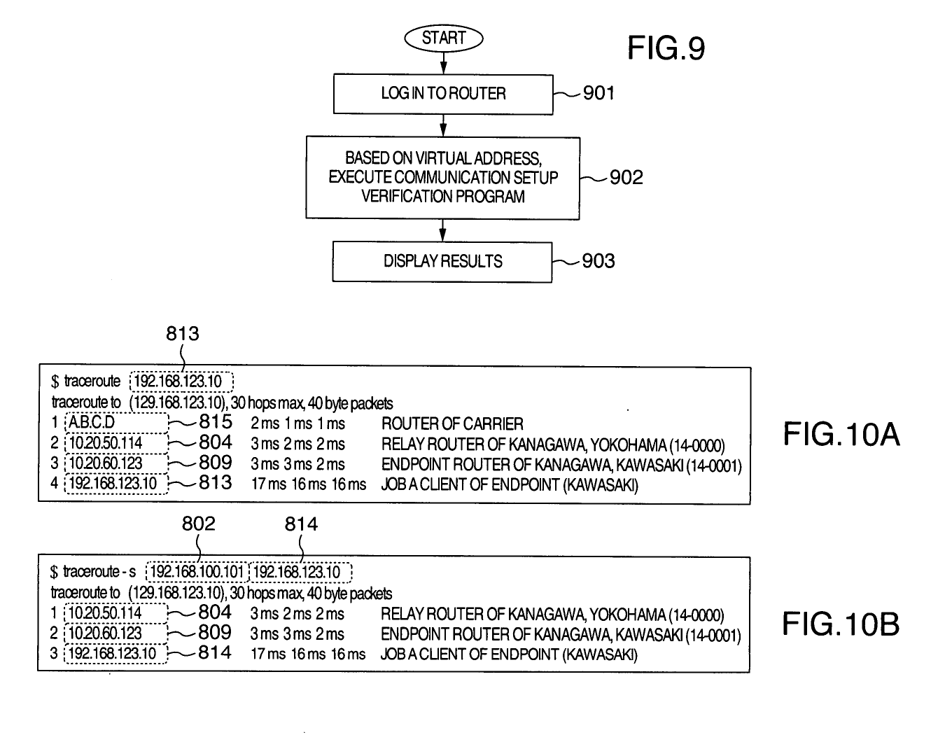

FIG. 9 is a flow diagram to verify the establishment of a path.

The CPU 302 starts processing, triggered by the start of a program (by the start of a terminal program xterm if the network management device is a Linux (registered trademark) based computer, or by the execution of a command prompt if it is Windows (registered trademark) or MS-DOS (Microsoft Disk Operating System) (registered trademark)).

The CPU 302 first logs in to a router that routes the communication data of IP communication path or VPN path for verifying the communication establishment (step 901). In this example, the log-in is done by specifying a management address 10.20.30.254 of the server router 200a.

Next, based on the virtual IP address assigned to a physical port on the server side of the router that was logged-in, the communication setup verification program 404 is executed (step 902). The allocation of the virtual IP address may be done manually by the network administrator or by executing a separately provided virtual IP address allocation program. Further, specifying the virtual IP address as a source address may be done manually by the network administrator or by executing a separately provided specification program. It is also possible to execute the communication setup verification program 404 without specifying the source address.

Next, the result of communication establishment verification is displayed (step 903).

FIGS. 10A and 10B show example screens that display results of the communication establishment verification when server routers send a test packet. FIG. 10A represents a result of the communication establishment verification for the IP communication path, and FIG. 10B represents a result for the VPN path.

In FIG. 10A, since the source IP address of the test packet is not specified, the test packet does not pass through the VPN path used by the job A server but is transferred to a router of the carrier adjacent the server router 200a and further through a relay router and an endpoint router to a job A client. As for the routers of the carrier, though not shown, at least one of them exists in the shared network 100a (100b) of FIG. 1. In FIG. 10B, the source IP address of the test packet is the IP address (virtual IP address) of the first network. So, if it is assumed that the destination IP address is a job A client, the server router decides that the test packet has been sent from the first network (192.168.100.0) and therefore allows it to pass through the VPN path. Between the server router and the relay router there is physically at least one router of carrier. They are close together on the VPN path, so the carrier's router is not aware of the presence of the VPN path. In this example, since the VPN path is cut off between the relay router 200b and the endpoint router 200c, the test packet is not transferred to the routers downstream of the relay router.

Comparison between FIG. 10A and FIG. 10B shows that since the test packet has reached the job A client in FIG. 10A but stops at the relay router in FIG. 10B, it can be determined that a failure has occurred between the relay router and the endpoint router on the VPN path (failure locating operation).

As described above, by virtually allocating an IP address of the network the user uses to the routers, the communication establishment on a VPN path can be verified.

With this invention, an operation management system can be provided which checks for the communication establishment of a VPN path by operating devices of a network provider without using facilities of the user.

It should be further understood by those skilled in the art that although the foregoing description has been made on embodiments of the invention, the invention is not limited thereto and various changes and modifications may be made without departing from the spirit of the invention and the scope of the appended claims.

1. An operation management method for a network system having a first computer belonging to a first network, a second computer belonging to a second network, and a first router, a second router and a management device belonging to a third network, wherein the first computer and the second computer are connected through a logical path built between the first router and the second router, wherein the first, second and third network are connected to one another, wherein the first and second network and the third network are independently operated;
the operation management method comprising the steps of:
holding as a first address of the first router in a memory device of the management device an address used by the first network but not used by the first computer, or an address used by the second network but not used by the second computer;
sending a first packet by the first router based on the first address; and
receiving a second packet corresponding to the first packet by the first router.

2. An operation management method according to claim 1, wherein, in the sending step, the first router sends the first packet to the first computer and,
in the receiving step, the first router receives the second packet that was sent from the first computer.

3. An operation management method according to claim 1, wherein, in the sending step, the first router sends the first packet to the second router and,
in the receiving step, the first router receives the second packet that was sent from the second router.

4. An operation management method according to claim 1, wherein the first packet is a packet to verify a communication establishment of the logical path, and the second packet is an acknowledge packet corresponding to the first packet.

5. An operation management method according to claim 1, further including the steps of:
holding in the management device an address used by the third network as a second address of the first router;
sending a third packet by the first router based on the second address; and
receiving a fourth packet corresponding to the third packet by the first router.

6. An operation management method according to claim 5, further including the step of:
comparing the second and the fourth packet by the first router to locate a failed point on the logical path.

7. A network system having a first, a second and a third network and performing an operation management on the first and second network and on the third network, independently of each other, the network system comprising:
a first computer belonging to the first network;
a second computer belonging to the second network, the first and second computer being connected through a logical path built between a first and a second router;
a first router and a second router belonging to the third network; and
a management device;
wherein the management device further includes
a memory device and
a unit to hold as a first address of the first router in the memory device an address used by the first network but not used by the first computer, or an address used by the second network but not used by the second computer;
wherein the first router has a unit to send a first packet based on the first address and a unit to receive a second packet corresponding to the first packet.

8. A network system according to claim 7, wherein the unit to send the first packet sends the first packet to the first computer through the first router, and
the unit to receive the second packet receives through the first router the second packet that was sent by the first computer.

9. A network system according to claim 7, wherein the unit to send the first packet sends the first packet to the second router through the first router, and
the unit to receive the second packet receives through the first router the second packet that was sent by the second router.

10. A network system according to claim 7, wherein the first packet is a communication establishment verification packet for the logical path and the second packet is an acknowledge packet corresponding to the first packet.

11. A network system according to claim 7, wherein the management device further holds in the memory device an address used by the third network as a second address of the first router;
wherein the first router sends a third packet based on the second address and receives a fourth packet corresponding to the third packet.

12. A network system according to claim 11, wherein the first router compares the second and the fourth packet to locate a failed point on the logical path.
